(19) United States
(12) Patent Application Publication
(10) Pub. No.: US 2025/0020863 A1
(43) Pub. Date: Jan. 16, 2025

(54) Photonic integrated circuits

(71) Applicant: Teknologian tutkimuskeskus VTT Oy, Espoo (FI)

(72) Inventors: Matteo Cherchi, Espoo (FI); Timo Aalto, Espoo (FI); Mikko Harjanne, Espoo (FI)

(21) Appl. No.: 18/714,602

(22) PCT Filed: Nov. 29, 2022
(86) PCT No.: PCT/FI2022/050797

§ 371 Date: May 30, 2024

(30) Foreign Application Priority Data
Nov. 30, 2021 (FI) 20216226

(51) Int. Cl. G02B 6/12; G02B 6/126; G02B 6/132; G02B 6/136

(52) U.S. Cl. CPC G02B 6/12004; G02B 6/12002; G02B 6/126; G02B 6/132; G02B 6/136; G02B 2006/12061; G02B 2006/12102; G02B 2006/12104; G02B 2006/1215

(57) ABSTRACT

According to an example aspect of the present invention, there is provided a photonic integrated circuit, comprising: a waveguide with an end having a tilted surface for reflecting light with a total internal reflection (TIR) mirror, and a functional surface for interacting with the light reflected by the TIR mirror, wherein the functional surface is directly deposited on to an antireflection coating on the waveguide. According to another aspect of the present invention there is provided a method for manufacturing a photonic integrated circuit.

### FIELD

The present invention relates to photonic integrated circuits. In particular, the present invention relates to photonic integrated circuits having integrated functionalities used in optical communications, sensing and imaging.

### BACKGROUND

Using functional elements with waveguides is disclosed in WO 2020/225479 A1. This application discloses a polarization rotator and an optical coupler with a waveguide. A birefringent waveplate having on one side a reflective surface is disclosed, which waveplate is arranged to receive light from a second end of the waveguide and to reflect light transmitted out from the coupler back into said coupler. The waveplate is further configured to cause said birefringent material to rotate the polarization of said reflected light, which amount of rotation depends on an angle of rotation of said birefringent waveplate with respect to said optical coupler.

Up-reflecting mirrors are disclosed in more detail in U.S. Pat. No. 9,658,396 B2. The US patent discloses a vertical optical coupler for planar photonics circuits such as photonics circuits fabricated on silicon-on-insulator wafers. The vertical optical coupler comprises a waveguide comprising: a first end configured to reflect light nearly vertical by total internal reflection between the waveguide and another medium, a second end to receive the light for reflection, and a third end to output the reflected light.

Turning mirrors are disclosed in more detail in U.S. Pat. No. 5,966,478. The US patent discloses an integrated optical circuit having a turning mirror. An end surface of a planar waveguide forms a turning mirror deflector surface. More specifically the circuit includes a planar optical waveguide formed within a cladding layer wherein the planar waveguide has a deflector end surface positioned adjacent to a region.

Total internal reflection (TIR) mirror devices are disclosed in more detail in publication U.S. Pat. No. 20,110,73972 A1. This publication discloses a vertical TIR mirror and fabrication thereof is made by creating a re-entrant profile using crystallographic silicon etching. Starting with a SOI wafer, a deep silicon etch is used to expose the buried oxide layer, which is the wet-etched, opening the bottom surface of the Si device layer. This bottom silicon surface is then exposed so that in a crystallographic etch, the resulting shape is a re-entrant trapezoid with facets. These facets can be used in conjunction with planar silicon waveguides to reflect the light upwards based on the TIR principle.

### SUMMARY OF THE INVENTION

It is an aim of the invention to provide improved photonic integrated circuits.

The invention is defined by the features of the independent claims. Some specific embodiments are defined in the dependent claims.

According to a first aspect of the present invention, there is provided a photonic integrated circuit, comprising a waveguide with an end having a tilted surface for reflecting light with a total internal reflection (TIR) mirror and a functional surface for interacting with the light reflected by the TIR mirror, wherein the functional surface is directly deposited on to an antireflection coating of the waveguide, using standard planar fabrication techniques, like those used in manufacturing semiconductor devices on silicon wafers.

According to a second aspect of the present invention, there is provided a method of manufacturing a photonic integrated circuit comprising a waveguide with an end having a tilted surface for reflecting light with a total internal reflection (TIR) mirror and a functional surface for interacting with the light reflected by the TIR mirror, the method comprising the steps of depositing the functional surface directly on to an antireflection coating on top of the waveguide, using standard planar fabrication techniques, like those used in manufacturing semiconductor devices on silicon wafers.

According to a third aspect of the present invention a photonic integrated circuit comprising a waveguide with an end having a tilted surface for reflecting light with a total internal reflection (TIR) mirror and a functional surface for interacting with the light reflected by the TIR mirror is used in optical communications, sensing or imaging.

Integrating functionalities into photonic integrated circuits (PICs) is highly desirable, but can be very challenging. This invention aims to solve the main barriers to this integration.

Micron-scale silicon waveguides according to the current invention offer a unique solution to the aforementioned issues. The waveguides can be made thicker than the telecom wavelengths, meaning that diffraction losses can be minimized in the TIR mirror.

### BRIEF DESCRIPTION OF THE DRAWINGS

FIG. 1A illustrates a cross-sectional side view of a waveguide comprising transmissive functional surface with an output light beam in accordance with at least some embodiments of the present invention;

FIG. 1B illustrates the top view of a waveguide comprising transmissive functional surface with an output light beam in accordance with at least some embodiments of the present invention;

FIG. 2A illustrates the side view of a waveguide comprising transmissive functional surface with an input light beam in accordance with at least some embodiments of the present invention;

FIG. 2B illustrates the top view of a waveguide comprising transmissive functional surface with an input light beam in accordance with at least some embodiments of the present invention;

FIG. 3A illustrates the side view of a waveguide comprising reflective functional surface in accordance with at least some embodiments of the present invention;

FIG. 3B illustrates the top view of a waveguide comprising reflective functional surface in accordance with at least some embodiments of the present invention;

FIG. 4A illustrates the side view of a waveguide comprising a reflective functional surface and a 50:50 multimode interference splitter in accordance with at least some embodiments of the present invention; and

FIG. 4B illustrates the top view of a waveguide comprising a reflective functional surface and a 50:50 multimode interference splitter in accordance with at least some embodiments of the present invention.

FIG. 5 illustrates a side view of two waveguides connected to each other by a 3D printed waveguide in accordance with least some embodiments of the present invention.

### EMBODIMENTS

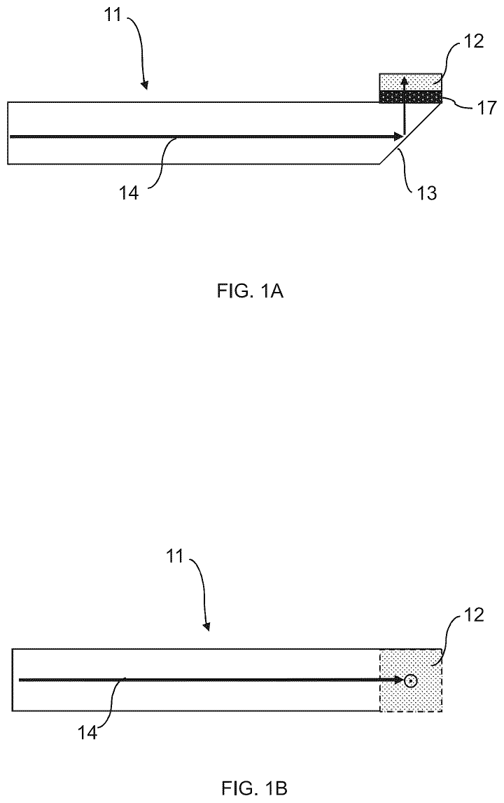

As appears from above, it has been found that integrating functionalities into photonic integrated circuits is possible when a functional surface is directly deposited onto the waveguide and a total internal reflection mirror is utilized. FIGS. 1A and 1B illustrate the side and top view of a waveguide 11 comprising transmissive functional surface 12 with an output light beam in accordance with at least some embodiments of the present invention.

The output light beam is represented by the line of light propagation 14, which passes through the waveguide 11 and is reflected by a total internal reflection (TIR) mirror 13 which turns the light beam to a functional surface 12. The TIR mirror 13 is at an about 45° angle with respect to the functional surface 12. Between the functional surface and the surface of the waveguide 11 there is an anti-reflection coating (ARC) 17, which ensures that the light beam is transmitted to the functional surface 12. The ARC 17 covers at least a part of the surface of the waveguide 11. Preferably, the ARC 17 covers at least the part of the surface of the waveguide 11 through which the reflected light is transmitted. The functional surface 12 is deposited on top of the ARC 17.

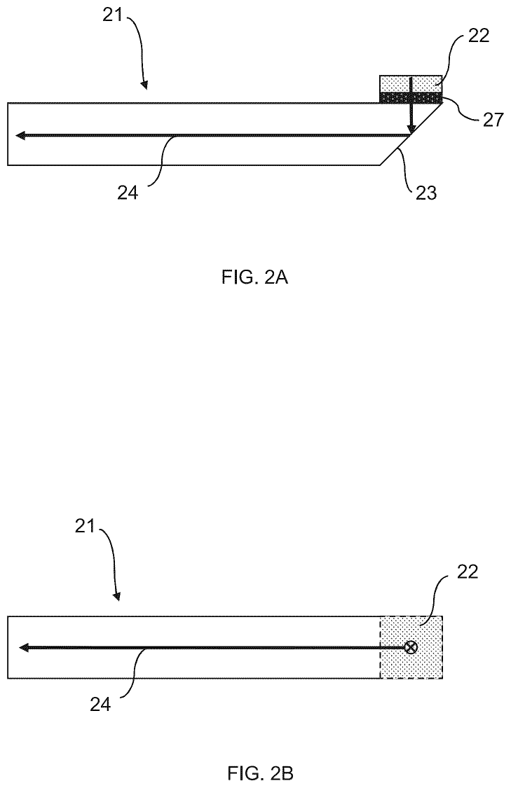

FIGS. 2A and 2B illustrate the side and top view of a waveguide 21 comprising transmissive functional surface 22 with an input light beam in accordance with at least some embodiments of the present invention.

The input light beam is represented by the line of light propagation 24, which passes through a functional surface 22 and is reflected by a TIR mirror 23 which turns the light beam into the waveguide 21. The TIR mirror 23 is at an about 45° angle with respect to the functional surface 22. Between the functional surface and the surface of the waveguide 21 there is an ARC 27, which ensures that the light beam is transmitted from the functional surface 22 to the total internal reflection mirror 23. The ARC 27 covers at least a part of the surface of the waveguide 21. Preferably, the ARC 27 covers at least the part of the surface of the waveguide 21 through which the reflected light is transmitted. The functional surface 22 is deposited on top of the ARC 27.

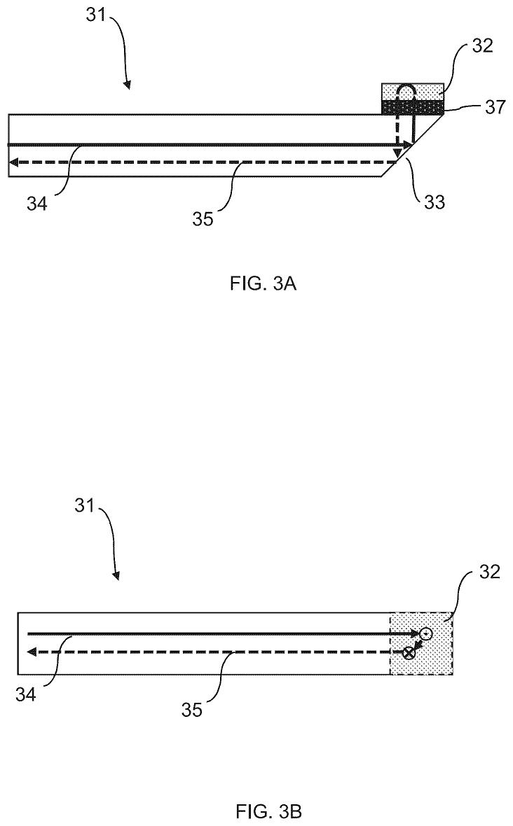

FIGS. 3A and 3B illustrate the side and top view of a waveguide 31 comprising reflective functional surface 32 in accordance with at least some embodiments of the present invention.

The incident light beam is represented by the line of light propagation 34, which passes through the waveguide 31 and is reflected by a TIR mirror 33 which turns the light beam to a functional surface 32. The TIR mirror 33 is at an about 45° angle with respect to the functional surface 32. The functional surface 32 is a reflective functional surface, which causes the incident light beam to be reflected back into the waveguide 31. The back-reflected light beam is represented by the line of back-reflected light propagation 35. The offset between the incident light beam and back-reflected light beam in the figure is only for the sake of clarity of illustration. Between the functional surface and the surface of the waveguide 31 there is an ARC 37, which ensures that the light beam is transmitted to the functional surface 32 and back to the waveguide 31. The ARC 37 covers at least a part of the surface of the waveguide 31. Preferably, the ARC 37 covers at least the part of the surface of the waveguide 31 through which the reflected light is transmitted. The functional surface 32 is deposited on top of the ARC 37.

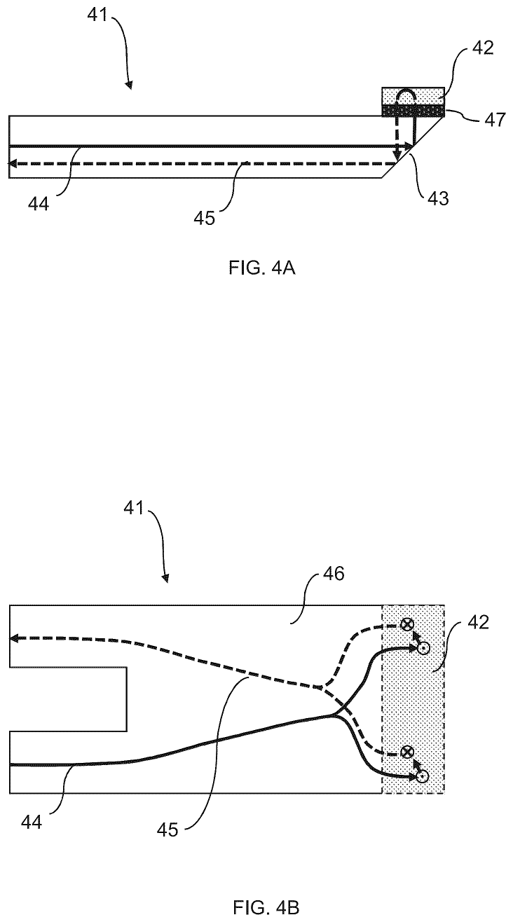

FIGS. 4A and 4B illustrate the side and top view of a waveguide 41 comprising a reflective functional surface 42 and a 50:50 multimode interference splitter 46 in accordance with at least some embodiments of the present invention.

The incident light beam is represented by the line of light propagation 44, which passes through the waveguide 41, which is configured to act as a 50:50 multimode inference (MMI) splitter 46 the incident light beam is split into two beams. Both beams are reflected by a TIR mirror 43 which turns them to a functional surface 42. The TIR mirror 43 is at an about 45° angle with respect to the functional surface 42. The functional surface 42 is a reflective functional surface which causes the incident light beams to be reflected back into the 50:50 MMI splitter 46. The back-reflected light beams are represented by the line of back-reflected light propagation 45. The shown offset between the incident light beam 44 and back-reflected light beam 45 is only for the sake of clarity of the figure. The MMI splitter comprises two ports, an input port and an output port. The incident light beam enters the MMI splitter 46 from the input port and the back-reflected light beam is recollected at the output port. The back reflective light beams interfere constructively in the output port of the MMI splitter 46. Between the functional surface and the surface of the MMI 46 there is an ARC 47, which ensures that the light beam is transmitted to the functional surface 42 and back to the MMI 46. The ARC 47 covers at least a part of the surface of the MMI 46. Preferably, the ARC 47 covers at least the part of the surface of the waveguide 41 through which the reflected light is transmitted. The functional surface 42 is deposited on top of the ARC 47.

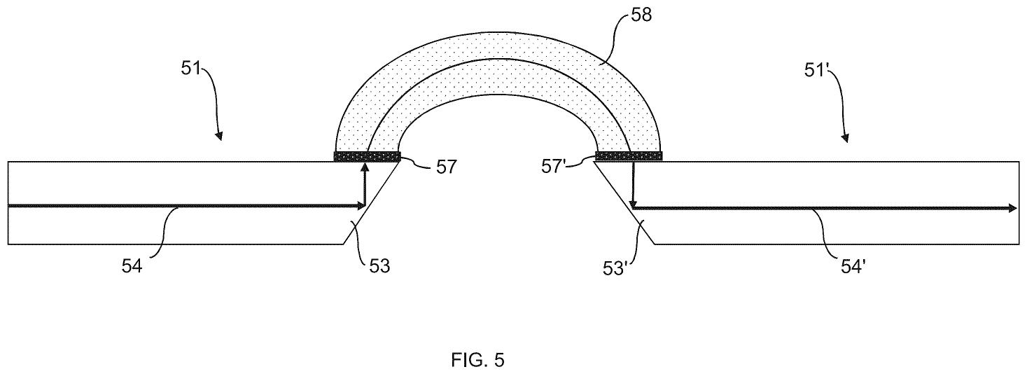

FIG. 5 illustrates a side view of two waveguides 51 and 51′ connected to each other by a 3D printed waveguide 58 in accordance with least some embodiments of the present invention.

The incident light beam is represented by the line of propagation 54, which passes through a first waveguide 51. The incident light beam is reflected by a first TIR mirror 53, which turns it to a 3D printed waveguide 58. The light beam is transmitted through the 3D printed waveguide 58 to a second waveguide 51′. The light beam as represented as a line of propagation 54′, is reflected by a second TIR mirror 53′ and is transmitted through the second waveguide 51′. Between the surfaces of the waveguides 51 and 51′ and the 3D printed waveguide 58 there are ARC 57 and 57′. The ARC 57 and 57′ cover at least part of the surface of the waveguides 51 and 51′. Preferably, the ARC 57 and 57′ cover at least the part of the surface of the waveguides 51 and 51′ through which the reflected light is transmitted. In addition, at least one of waveguides 51 and 51′ has a functional surface deposited on them. The functional surface is located between the ARC 57 or 57′ and the connecting 3D waveguide 58. In an embodiment, both waveguides 51 and 51′ have a functional surface deposited on them. In an embodiment, these functional surfaces are mutually identical and in another embodiment, the functional surfaces are different to each other and provide different functionalities.

The embodiment of FIG. 5 is an alternative way to transmit the light to a send waveguide without using the MMI splitter. In this case two up-reflecting mirrors with ARC and a functional layer in at least one of them, are connected using a 3D printed waveguide. This approach has three main advantages: 1. no need for back-reflectors (also avoiding possible associated losses); 2. Unlimited wavelength range of operation, unlike 50:50 MMI splitters that operate over around 100 nm bandwidth; 3. In principle the two up-reflecting mirrors can have two different functional layers, meaning that the same device can provide two different functionalities at the same time. This approach is functionally equivalent to the standard approach of cutting a narrow trench in a horizontal waveguide, but provides the advantage of working on a horizontal surface.

According to an embodiment there is provided a photonic integrated circuit, comprising: a waveguide 11 with an end having a tilted surface for reflecting light with a total internal reflection (TIR) mirror 13; and a functional surface 12 for interacting with the light reflected by the TIR mirror 13; wherein the functional surface 12 is directly deposited on to an antireflection coating 17 on the waveguide 13.

According to an embodiment of the photonic integrated circuit, the functional surface 12 is a reflecting functional surface, a transmissive functional surface or a polarization rotating functional surface.

The transmissive functional surface may be, for example:
a thin metalens to focus on a tiny device (e.g. ultra short superconducting nanowire single-photon detector (SNSPD) or small volume photon detector (PD));
thin metalens(es) expanding the beam to couple efficiently to a single-mode fiber (SMF);
2D materials for photodetection also in combination with metasurfaces to enhance the operation;
2D materials or Epsilon-near-zero materials (ENZ materials) or a material with high second order nonlinearity (like Barium Titanate or a nonlinear polymer) for off-chip amplitude or phase modulation also in combination with metasurfaces to enhance the operation;
a metasurface waveplate for polarization rotation of the input/output light with or without 2D materials to enhance and/or tune and/or switch the operation of the metasurfaces; or
nonreciprocal metasurface as Faraday rotator also in combination with 2D materials to enhance and/or tune and/or switch the operation of the metasurfaces.

The reflective functional surface may be a reflective metasurface waveplate for in-chip polarization rotation, a reflective nonreciprocal metasurface as in-chip Faraday rotator or in-chip Faraday mirror, 2D materials or ENZ materials also in combination with a mirror (e.g. metal or thin film) for on-chip amplitude or phase modulation.

The functional surface 12 may also have both transmissive and reflective properties. For example, they may be Fabry-Perot filters made with multilayers also in combination with a photonic crystal to guide light laterally and avoid light diffraction (like in a PC fibre).

The waveguide can have a rectangular shape having different dimensions. According to an embodiment the thickness of the waveguide 11 is 1-12 μm, such as 2-10 μm, for example 3-8 μm and the width of the waveguide 11 is 1-50 μm, such as 10-40 μm, for example 20-30 μm. For example, the thickness of the waveguide is 3 μm and the width of the waveguide is 3 μm.

According to an embodiment the thickness of the functional surface is 100 nm-3 μm, such as 200 nm-2 μm, for example 300 nm-1 micron and the surface area of the functional surface 12 is in the same order of magnitude as the cross section waveguide, for example 3×3 μm². According to an embodiment, the functional surface 100 is relatively thin such that the width of the functional surface 100 is at least 5 times the thickness of the functional surface 100. In an embodiment, also the length of the functional surface 100 is at least 5 times the thickness of the functional surface 100. The length of the functional surface 100 is the dimension along the length of the waveguide 11 and the width is the dimension co-directional with the width of the waveguide 11.

According to an embodiment the waveguide 11 is made of crystalline material, preferably silicon.

The ARC can be implemented either as a single layer or as a multilayer, or as a metamaterial. The multilayer implementation is used to improve the performance of the waveguide, such as broadening the wavelength range of operation or reaching higher suppression of reflections. However, the overall thickness of the ARC layer is in the order of quarter wave, in other words, a quarter of the operating wavelength divided by the average refractive index of the ARC material. According to one embodiment the thickness of the ARC 17 is 150-250 nm, such as 170-220 nm, for example 180-200 nm.

According to an embodiment the waveguide 11 further comprises a splitter, for example a 50:50 multimode interference (MMI) splitter 46. One example is the use of a 50:50 splitter, preferably in the form of a 50:50 MMI splitter, to reroute the light from an input waveguide to a separate output waveguide, by using the resulting Michelson interferometer. However, any type of 2×2 50:50 splitter can be used, i.e. a splitter with two input ports and two output ports that split the light coming from one of the two input ports evenly into the two output ports. Another physical implementation that can be used is based on so-called directional couplers, i.e. two waveguides brought very close so that they can couple light to each other. In particular, adiabatic directional couplers could be used to achieve operation over a broad wavelength range.

According to an embodiment, the photonic integrated circuit further comprises a second waveguide 51′ with an end having a tilted surface for reflecting light with a total internal reflection (TIR) mirror 53′ and an antireflection coating 57′, and also a 3D printed waveguide 58 having a first end and a second end. The first end of the 3D printed waveguide is connected to the functional surface of the first waveguide 51 and the second end of the 3D printed waveguide is connected to the second waveguide 51′ at the end having a tilted surface. The connection is made such that the photonic integrated circuit is configured to transmit light from the first waveguide 51 to the second waveguide 51′ through the 3D printed waveguide 58.

In an embodiment, also the second waveguide 51′ comprises a functional surface for interacting with the light reflected by the TIR mirror 53′ and the functional surface is directly deposited on to the antireflection coating 57′. In an embodiment, the functional surface on the first waveguide 51 is identical to the functional surface on the second waveguide 51′. In another embodiment, the functional surfaces on the first and second waveguides are mutually different and serve different purposes.

In an embodiment, the first waveguide 51 is identical to the waveguide 11 according any one embodiment described in this specification. In an embodiment, also the second waveguide 51′ is identical to the waveguide 11 according any one embodiment described in this specification. In an embodiment, the first and second waveguides 51, 51′ are different to each other. In another embodiment, the first and second waveguides 51, 51′ have mutually similar properties.

In an embodiment, both the first and second waveguides 51, 51′ are manufactured on the same silicon on insulator, SOI, substrate. In an embodiment, both the first and second waveguides 51, 51′ are formed in the silicon on insulator substrate.

According to another embodiment the photonic integrated circuit further comprises a second waveguide 51′ with an end having a tilted surface for reflecting light with a total internal reflection (TIR) mirror 53′ and an antireflection coating 57′, and a 3D printed waveguide 58. The 3D printed waveguide is connected to the top of the first waveguide 51 and the second waveguide 51′ at their ends having tilted surfaces. The photonic integrated circuit is configured so that light can be transmitted from the first waveguide 51 to the second waveguide 51′ through the 3D printed waveguide 58.

This is called photonic wire bonding and is associated with several advantages, such as no need for back-reflectors, there is unlimited wavelength range of operation, the possibility to have two different functional layers deposited on the two separate waveguides and therefore two different functionalities may be provided simultaneously. This approach would be equivalent to an approach of cutting a slot in a waveguide, but would provide the advantage of working on a horizontal surface.

According to an embodiment, the total internal reflection mirror 13 is at a 35° to 55°, such as a 40° to 50° angle with respect to the functional surface 12.

According to an embodiment, the total internal reflection mirror 13 is at a 45° angle with respect to the functional surface 12.

According to an embodiment there is provided a method of manufacturing a photonic integrated circuit wherein the method comprises the step of depositing the functional surface 12 directly on to an antireflection coating on top of the waveguide 11.

According to an embodiment the waveguide 11 is manufactured on a silicon on insulator substrate (SOI) using manufacturing technologies such as lithography, layer deposition and etching. Suitable etching techniques include dry etching, such as deep reactive ion etching (DRIE), and more specifically the Bosch process.

According to an embodiment the total internal reflection mirror (13) is manufactured using wet-etching.

According to an embodiment the photonic integrated circuit as described above can be used in optical communications.

With the current invention it is possible to fabricate thin surface materials on top of the waveguide layer and, at the same time, impinge normal to the surface material itself. For example, it is possible to fabricate a half-wave plate as a subwavelength metasurface to rotate the light polarization such that the half-wave plate is fabricated directly on top of ARC on the waveguide and above the mirror. The functional surface can be fabricated monolithically on top of the waveguide layer.

The current invention manipulates light either coupled out from the waveguide through an at least partially transparent functional surface, coupled into the chip through an at least partially transparent functional surface or coupled out from and then back reflected into the waveguide by relying on reflective layer. This can be done by combining a transmissive surface with a metal mirror or a dielectric mirror.

The functional surface according to the invention is manufactured by direct layer deposition, for example though sputtering, epitaxy, different types of chemical vapour depositions such as plasma enhanced chemical vapour deposition (PECVD) or electroplating, or atom layer deposition. In some cases the surface may also need to be etched, and these techniques may vary from wet and dry etch. The patterns can be defined through, for example, photolithography, e-beam lithography, ion-beam lithography, or nanoimprinting. In general, the functional surface can be deposited on to the waveguide using planar fabrication techniques, like those used in manufacturing devices on silicon wafers. In deposition, a layer of material is grown on a surface. Methods in which a ready-made structure, such as a film, is attached on a surface are not deposition methods.

Many interesting surface materials, including 2D materials (like graphene, i.e. 1-atom layer or a few atom layers thick surfaces) or metasurfaces (thin surfaces composed by artificial dielectric or metallic “atoms”) achieve very effective free-space light manipulation despite their inherent subwavelength nature. For example, 2D materials can be used as active electro-optical devices to modulate or detect light in an ultra-broad wavelength range, whereas metasurfaces can be designed either as passive devices to focus light, filter wavelengths, to manipulate the light polarization (e.g. as ultra-thin waveplates), or as active electro-optical devices when suitable electro-optic materials are included.

Furthermore, also the combination of metasurfaces with 2D materials can lead to active electro-optical control of the metasurface properties, or even to non-reciprocal effect, like Faraday rotation. Another interesting class of materials are epsilon-near-zero materials (e.g. ITO) that achieve giant changes of the complex refractive index, meaning that thin layers (i.e. subwavelength thickness) of these materials can be used to modulate amplitude and phase of light. In some embodiments, this allows improved performance, thanks to the longer interaction length of light propagating in-plane instead of out-of-plane. But in some embodiments, like metasurfaces for polarization manipulation, the light must impinge on the layer.

In principle, this can be achieved by cutting a slot across the waveguide cross-section, to insert the surface material in the slot. This poses two main challenges: 1. the light exiting the waveguide will strongly diffract when propagating in the slot, leading to losses. In particular, when the mode dimension is smaller than the wavelength, the losses will easily become unacceptable. 2. Inserting a thin layer in a submicron slot is not a trivial integration process, which requires very precise tools, not to mention the challenges of handling very thin layers that can easily break or bend in the process. Furthermore, the process is not easily scalable to large volumes at wafer scale, unlike standard layer-by-layer microelectronic fabrication processes.

According to an embodiment the functional surface 12 is a metasurface.

According to an embodiment, the waveguide 11 is formed by a portion of a patterned silicon layer on an insulating layer.

According to an embodiment, the antireflection coating and the functional surface 12 are locally located on the surface of the waveguide 11 at the end having the tilted surface such that light propagated through the waveguide is reflected by the mirror 13 through the antireflection coating to the functional surface 12. The antireflection coating and the functional surface 12 being “locally located” means that the antireflection coating and the functional surface 12 do not cover the whole length of the waveguide but the surface of the waveguide is substantially free of antireflection coating outside the area of reflection caused by the mirror 13.

According to an embodiment the metasurface is manufactured utilizing a technique as described in the article “The advantages of metalenses over diffractive lenses” J. Engelberg et al.

According to an embodiment the metasurface is manufactured utilizing a technique as described in the article “Metalenses: Versatile multifunctional photonic components” M. Khorasaninejad et al.

According to an embodiment the metasurface is manufactured utilizing a technique as described in the article “Broadband and wide field-of-view plasmonic metasurface-enabled waveplates” Z. H. Jiang et al.

According to an embodiment the metasurfaces can be designed as active electro-optical devices when suitable electro-optic materials are included as described in the article “Electro-optic spatial light modulator from an engineered organic layer” IC. Benea-Chelmus et al.

According to an embodiment the photonic wire bonding can be manufactured utilizing a technique as described in the article “In situ 3D nanoprinting of free-form coupling elements for hybrid photonic integration” P.-I. Dietrich et al.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present photonic integrated circuit has a broad range of uses. In particular, it can be used in optical communications, sensing and imaging.

ACRONYMS LIST

| | |
|---|---|
| ARC | Anti-reflection coating |
| TIR | Total internal reflection |
| MMI | multimode interference |

REFERENCE SIGNS LIST

| | |
|---|---|
| 11, 21, 31, 41, 51, 51′ | Waveguide |
| 12, 22, 32, 42 | Functional surface |
| 13, 23, 33, 43, 53, 53′ | TIR mirror |
| 14, 24, 34, 44, 54, 54′ | Line of light propagation |
| 35, 45 | Line of back-reflected light propagation |
| 46 | MMI splitter |
| 17, 27, 37, 47, 57, 57′ | Anti-reflection coating |
| 58 | 3D printed waveguide |

### CITATION LIST

### Patent Literature

U.S. Pat. No. 9,658,396 B2
WO 2020/225479 A1

### Non Patent Literature

PI. Dietrich et al., “In situ 3D nanoprinting of free-form coupling elements for hybrid photonic integration”, Nature Photonics 12, 241-247 (2018)
IC. Benea-Chelmus et al., “Electro-optic spatial light modulator from an engineered organic layer”, Nature Communications 12, 5928 (2021)
J. Engelberg et al., “The advantages of metalenses over diffractive lenses”, Nature Communications 11, 1991 (2020)
M. Khorasaninejad et al., “Metalenses: Versatile multifunctional photonic components”, Science 358, 6367 (2017)
Z. H. Jiang et al., “Broadband and wide field-of-view plasmonic metasurface-enabled waveplates” Scientific Reports 4, 7511 (2014)

1. A photonic integrated circuit, comprising:
at least a first waveguide with an end having a tilted surface for reflecting light with a total internal reflection (TIR) mirror; and
a functional surface for interacting with the light reflected by the TIR mirror; wherein the functional surface is directly deposited on to an antireflection coating on the first waveguide.

2. The photonic integrated circuit according to claim 1, wherein the functional surface is a reflecting functional surface or a transmissive functional surface.

3. The photonic integrated circuit according to claim 1, wherein the thickness of the functional surface is 100 nm-3 μm, such as 200 nm-2 μm, for example 300 nm-1 μm.

4. The photonic integrated circuit according to claim 1, wherein the first waveguide is made of crystalline material, preferably silicon.

5. The photonic integrated circuit according to claim 1, wherein the thickness of the first waveguide is 1-12 μm, such as 2-10 μm, for example 3-8 μm.

6. The photonic integrated circuit according to claim 1, wherein the first waveguide further comprises a splitter, for example a 50:50 multimode interference (MMI) splitter.

7. The photonic integrated circuit according to claim 1, wherein the total internal reflection mirror is at 40° to 50° angle, such as at a 45° angle, with respect to the functional surface.

8. A The photonic integrated circuit according to claim 1, wherein the thickness of the antireflection coating is 150-250 nm, such as 170-220 nm, for example 180-200 nm.

9. The photonic integrated circuit according to claim 1, wherein the width of the first waveguide is 1-50 μm, such as 10-40 μm, for example 20-30 μm.

10. The photonic integrated circuit according to claim 1, wherein the first waveguide is formed by a portion of a patterned silicon layer on an insulating layer.

11. A The photonic integrated circuit according to claim 1, wherein the antireflection coating and the functional surface are locally located on the surface of the first waveguide at the end having the tilted surface such that light propagated through the first waveguide is reflected by the mirror through the antireflection coating to the functional surface.

12. The photonic integrated circuit according to claim 1, further comprising:
a second waveguide with an end having a tilted surface for reflecting light with a total internal reflection (TIR) mirror and an antireflection coating, and
a 3D printed waveguide having a first end and a second end,
wherein the first end of the 3D printed waveguide is connected to the functional surface of the first waveguide and the second end of the 3D printed waveguide is connected to the second waveguide at the end having a tilted surface such that the circuit is configured to transmit light from the first waveguide to the second waveguide through the 3D printed waveguide.

13. The photonic integrated circuit according to claim 12, wherein both the first waveguide and the second waveguide have the properties of the at least one first waveguide of claim 1.

14. The photonic integrated circuit according to claim 1, wherein a width of the functional surface is at least 5 times the thickness of the functional surface.

15. The photonic integrated circuit according to claim 1, wherein a length of the functional surface is at least 5 times the thickness of the functional surface.

16. A method of manufacturing a photonic integrated circuit according to claim 1, the method comprising the steps of depositing the functional surface directly on to an antireflection coating on top of the first waveguide.

17. The method according to claim 16, wherein the first waveguide is manufactured on a silicon on insulator, SOI, substrate.

18. The method according to claim 17, wherein the first waveguide is formed in the silicon on insulator substrate.

19. The method according to claim 16, wherein the steps of depositing the functional surface comprises adding material directly on the surface of the antireflection coating by means of sputtering, epitaxy, chemical vapour deposition, electroplating, or atom layer deposition.

20. A method comprising using the photonic integrated circuit according to claim 1 in optical communications, sensing or imaging.
